(19) United States
(12) Patent Application Publication
(10) Pub. No.: US 2002/0161096 A1
(43) Pub. Date: Oct. 31, 2002

(54) Extruded polyolefin moulding

(76) Inventors: Jacobus A. Loontjens, Meerssen (NL); Martin A. Van Es, Brunssum (NL); Paulus A.M. Steeman, Geleen (NL); Patrick E. Voets, Born (NL); Sander Langereis, Geleen (NL)

Correspondence Address: PILLSBURY WINTHROP, LLP, P.O. BOX 10500, MCLEAN, VA, 22102, US

(21) Appl. No.: 10/050,039

(22) Filed: Jan. 17, 2002

Related U.S. Application Data
(63) Continuation of application No. PCT/NL00/00468, filed on Jul. 2, 2000.

(30) Foreign Application Priority Data
Jul. 19, 1999 (NL) 1012363
Nov. 8, 1999 (NL) 1013520

(51) Int. Cl. C08K 3/34

(52) U.S. Cl. 524/445

(57) ABSTRACT

Extruded moulding prepared from a polyolefin-based composite material. The composite material comprises 98-50 wt % of a polyolefin, 1-50 wt % of another homo-or copolymer and 0.1-70 wt % of a layered, interstratified clay. The moulding normally contains 0.1-10 wt. % of the clay and can be aftertreated after extrusion.

Such a nanocomposite has a low viscosity in the melt at high shear forces, so in the melting apparatus, and also a high viscosity in the melt at low shear forces, so after the melt has left the melting device, which is beneficial during the extrusion process.

Further advantages are that the balance between rigidity and toughness and the balance between rigidity and transparency of the mouldings are better.

The moulding can be obtained from a concentrate of the nanocomposite and a polyolefin. This concentrate generally contains 10-70 wt. % of the clay.

### CROSS-REFERENCE TO RELATED APPLICATIONS

This is a Continuation of International Application No. PCT/NL00/00468 filed Jul. 3, 2000 which designated the U.S. and was published in the English language. The contents of this PCT application are incorporated in their entirety by reference.

The invention relates to an extruded moulding, prepared from a polyolefin-based composite material.

Such an extruded polyolefin-based moulding is generally known, for instance from Kunststoff Handbuch, Becker et al., Carl Hanser Verlag, Munich, 1990.

Within the context of the present application an ‘extruded moulding’ is understood to be any object to be obtained by means of extrusion, in particular a film (for instance a flat or a blown film), a foam, a thin-walled object (for instance a bottle, a tube or a hose), a thick-walled object (for instance a profile, tube or plate), a fibre, a monofilament or a thread, for instance cable sheathing. ‘Film’ is understood to be a material with a thickness that is small in comparison with the length and/or width of the material, its maximum thickness being about 250 micrometres. A ‘thin-walled object’ is understood to be an object at least part of which consists of a material with a thickness of more than about 250 micrometres and less than about 1 mm. A ‘thick-walled object’ is understood to be an object at least part of which consists of a material with a thickness of more than about 1 mm.

By ‘extrusion’ is meant a process in which a melt is formed in a melting apparatus, from which subsequently a moulding is produced, and which comprises at least a step in which a cooling melt is shaped to a moulding.

A drawback of the use of polyolefins for preparing extruded mouldings is that in many cases the polyolefin has a high viscosity in the melt, which makes rapid processing of the polyolefin to a moulding impossible. The extrusion throughput is consequently low, which implies a less economic process operation.

The use of a polyolefin having a low viscosity in the melt for extrusion to a moulding leads to melt fracture and/or sagging of the moulding after the melt has left the melting apparatus, which makes stable process operation impossible. In addition, the mechanical properties of such a moulding are not as good as when a polyolefin having a high viscosity in the melt is used.

The foregoing indicates that with application of the polyolefin-based composite materials according to the state of the art it is not possible to achieve rapid processing to mouldings with good properties.

The aim of the present invention is to provide an extruded moulding prepared from a polyolefin-based composite material, which is free of said drawbacks.

The invention relates to a moulding which is prepared from a polyolefin-based composite material comprising 98-50 wt. % of a polyolefin, 1-50 wt. % of another homo- or copolymer and 0.1-70 wt. % of a layered, interstratified clay.

The fact is that surprisingly it has appeared that such a composite material, hereinafter also called nanocomposite, has a low viscosity in the melt at high shear forces, so in the melting apparatus, and also a high viscosity in the melt at low shear forces, so after the melt has left the melting device. The term “nanocomposite” denotes the fact that the clay has at least one dimension in the about 1-100 nanometer size range.

Further advantages are that the balance between rigidity and toughness and the balance between rigidity and transparency of the mouldings are better.

Another advantage is that the moulding possesses better barrier properties, i.e. the moulding is less permeable to gases.

Suitable clays are for example smectic clay minerals, vermiculite clay minerals and micas, and synthetic micas. Examples of suitable smectic clay minerals are montmorillonite, nontronite, beidellite, volkonskoite, hectorite, stevensite, pyroysite, saponite, sauconite, magadiite, bentonite and kenyaite. Preferably montmorillonite is chosen.

To form the nanocomposite, however, the clay has to be dispersed very thoroughly in the polyolefin.

This is achieved by means of the process described in the following: the nanocomposite is obtained by impregnating a layered, swellable clay which is interstratified with a tetraalkylonium cation, with at least one polymerizable monomer and then mixing this impregnated clay with a polyolefin and a peroxide, at a temperature above the melting temperature of the polyolefin.

In order to be able to be impregnated with one or more polymerizable monomers, the layered clay first has to be treated with a tetraalkylammonium or tetraalkylfosfonium salt, as described for instance in “Interlayer Structure and Molecular Environment of Alkylammonium Layered Silicates”, R. A. Vaia, T. K. Teukolsky, E. P. Giannelis, Chem. Mater. 1994, Vol 6, No.7, 1017-1022. The result is a so-called interstratified clay.

The polymerizable monomers that are used in the process according to the invention can be polar, less polar and non-polar monomers. The monomers have at least one unsaturated C═C-bond. By preference, at least one monomer of a polar nature is used. Polar monomers are monomers having a dipole moment greater than 1.0 D. Less polar monomers are monomers having a dipole moment of less than 1.0 D. Non-polar monomers do not have a dipole moment. The polarity is measured in the gas phase (Handbook of Chemistry and Physics, 66th Edition, CRC Press, pp. E58-E60).

Polar monomers are for instance monomers which contain at least one nitrogen and/or oxygen atom. Examples of such monomers are monomers containing a carboxylic acid group, an ester group, a hydroxyl group, an epoxy group, an anhydride group, a nitrile group, an amide group, an imide group or a pyridine group. Examples are, for instance, acrylic acid, methacrylic acid, maleic acid, fumaric acid, itaconic acid, citric acid, maleic anhydride, itaconic anhydride, glycidyl acrylate, glycidyl methacrylate, allyl glycidyl ether, allyl amine, aminoethyl methacrylate, 2-hydroxyethyl acrylate, maleimide, 2-vinyl pyridine and 1-vinyl-2-pyrrolidone. Preferably, monomers containing an epoxy group are selected from this group of monomers, with particular preference being given to glycidyl methacrylate.

Examples of less polar monomers and non-polar monomers are stryrene-containing monomers or diene-containing monomers. Examples of these are styrene, α-methylstyrene, p-methylstyrene, 1,3-butadiene and isoprene. Preferably, a styrene-containing monomer is chosen from this group of monomers. By special preference, these are styrene and α-methylstyrene.

The layered, interstratified clay is preferably impregnated with a mixture of two monomers which are copolymerizable, the first monomer being a polar monomer and the second one being a monomer that is non-polar or less polar than the first one. The mixture of two monomers preferably consists of a mixture of a styrene-containing monomer and a monomer containing an epoxy group.

As peroxide can be used the known and commercially available peroxides. Examples of peroxides that can be used are: t-butyl peroxybenzoate, t-butyl peroxy-2-ethylhexanoate, bis(t-butyl peroxyisopropyl)benzene, acetyl cyclohexane sulphonyl peroxide, t-butyl hydroperoxide, di-lauroyl peroxide and di-cumyl peroxide. The peroxides are generally used in an amount of 0.01 -0.5 wt. % relative to the amount of the polyolefin in the polyolefin-based composite material, preferably in an amount of 0.05-0.3 wt. %. The peroxide can be mixed together with the monomer during the impregnation of the clay; it can also, and with preference, be added during the mixing of the impregnated clay with the polyolefin, or be present in the polyolefin. It is preferred that also the polyolefin contains at least part of the monomer(s), before the mixing of the impregnated clay with the polyolefin. As a result of the process of the present invention, the polymerizable monomer(s) is (are) polymerized to form the corresponding homo- or copolymer, as well as to a graft (co) polymer of the polyolefin.

Suitable polyolefines are homo- or copolymers of α-olefines, internal olefines, cyclic olefines and di-olefines. In particular, the process is suitable for enhancement of the rigidity of homo- or copolymers of α-olefines. The α-olefine is preferably chosen from the group comprising ethylene, propylene, n-butene, n-pentene, n-heptene and n-octene (substituted or non-substituted), mixtures thereof being also suitable. More preferably, a homo- or copolymer of ethylene and/or propylene is used as polyolefin. Examples of such polyolefines are homo- and copolymers of (semi-) crystalline polyethylene of both high and low density (for instance HDPE, LDPE and LLDPE) and polypropylene homo- and copolymers (PP and EMPP). It is also possible to use as polyolefin amorphous or rubber-like copolymers on the basis of ethylene and another α-olefine; for instance EPM rubber (ethylene/propylene rubber), EADM rubber (ethylene/α-olefin/diene rubber), and in particular EPDM rubber (ethylene-propylene/diene rubber).

It is also possible to make use of mixtures of polyolefines.

When linear polyolefines, such as HDPE, LLDPE and isotactic polypropylene are used, the effect of the application of the nanocomposite instead of only the polyolefin on the speed of processing to mouldings with good properties is greatest.

The polyolefin-based composite material may contain the usual additives for polyolefines, such as for instance UV stabilizers, flame retardants, antioxidants, nucleating agents, colorants and plasticizers.

The layered swellable clay, treated with a tetraalkylonium cation, can be impregnated with at least one monomer and a peroxide by for instance mixing the monomer with the peroxide and then mixing the resulting mixture with the clay. Then the impregnated clay can be kneaded and mixed together with the olefinic homo- or copolymer. Another possibility is to place the interstratified clay on a powder bed of olefinic homo- or copolymer. Next, the monomer and the peroxide are applied onto the clay and then the whole is mixed with the rest of the olefinic homo- or copolymer and subsequently kneaded. Kneading of the impregnated clay and the peroxide with an olefinic homo- or copolymer takes place at a temperature above the melting temperature of the polyolefin, and above the decomposition temperature of the peroxide. This is normally done in a single- or twin-screw extruder, but it is also possible to make use of for instance a static mixer or a batch mixer.

The amount of clay can be chosen freely within the indicated range; the amount is determined for instance by the desired properties of the extruded moulding to be obtained and depends, among other things, on the polyolefin chosen, the degree of interstratification of the clay and the degree of dispersion in the polyolefin. Depending on the amount of clay in the nanocomposite, the nanocomposite can either be directly extruded to a moulding or first be mixed with another polyolefin before being processed to a moulding. Said another polyolefin must be (made) compatible with the polyolefin in the nanocomposite; preferably the another polyolefin is the same type of polyolefin as the polyolefin in the nanocomposite.

The nanocomposite can contain 0.1 to 70 wt. % of clay. A nanocomposite which will be extruded directly to a moulding normally contains 0.1 to 30 wt. % of clay. A concentrate of a nanocomposite normally contains 10 to 70 wt. % of clay, preferably 40-60 wt. % of clay. The amount of clay in the extruded moulding preferably is 0.1-10 wt. %.

If the amount of clay in the nanocomposite is higher than the desired amount of clay in the extruded moulding, further blending of the nanocomposite with the polyolefin prior to production of the extruded moulding is of advantage. This blending can be done in two ways. Granulate or powder of the nanocomposite concentrate can be blended with granulate or powder of another polyolefin, after which it is extruded to a moulding. Such a mixture can also first be extruded to form a granulate, which is then used for extrusion of a moulding. The granulate or powder of the nanocomposite concentrate and the granulate or powder of the another polyolefin can also be extruded to a moulding directly after having been blended.

The polyolefin based composite material for preparing the extruded moulding of the present invention has a unique combination of a low viscosity in the melt at high shear forces, and a high viscosity in the melt at low shear forces.

The nanocomposite has a shear-rate dependant viscosity ratio (SVR), which has not been shown with prior art products.

The SVR is hereinafter defined as the ratio of the viscosity η* (in Pa.s) at a shear-rate ω (in rad/s), of 0.1 and the viscosity η* at a shear rate of 100, the viscosity being determined according to ISO/DIN 6721-10. Defined as such, the SVR of the nanocomposite used in the present invention has a value of at least 15, and more preferably a value of at least 25, and even more preferred a value of at least 30.

The above in formula form:

$$SVR = \frac{{η}^{*} ( ω = 0.1 η )}{{η}^{*} ( ω = 100 )} \geq 15 ;$$

preferably≧25; more preferred≧30

In the polyolefin based material of the invention an additional polar polymer can be present, like a nylon, styrene/acrylonitrile copolymer (SAN), acrylonitril/butadiene/styrene terpolymer (ABS), a styrene/carboxylic acid or styrene/carboxylic acid anhydride copolymer (like styrene/maleic anhydride (SMA) copolymer). Preferably a nylon (or polyamide) is present; the resulting polymeric composition is, due to its ingredients, a well compatibilized blend of a polyolefin and a nylon. As nylons can be used polycaprolactam (nylon 6), polyhexamethylene adipamide (nylon 6,6), polytetramethylene adipamide (nylon 4,6), as well as other nylons known in the art.

The extruded moulded part according to the invention optionally comprises additives, for example other types of fillers and reinforcing materials, for example glass fibres and talcum, flame retardants, foaming agents, stabilizers, antiblocking agents, slipping agents, acid scavengers, antistatics, flow-promoting agents and colorants and pigments.

The extruded moulded part according to the invention may also consist of one or of several other polymeric layers. Examples of suitable other polymeric layers are layers of ethylene-propylene copolymers, ethylene-propylene-butene copolymers and layers containing a copolymer of ethylene and vinyl alcohol (EVA).

In particular, the known techniques can be used to produce the extruded moulding according to the invention, for example extrusion and coextrusion.

With these techniques the following mouldings are obtained for instance: sheets, flat film, blown film, profiles, tubes, foams, fibres and tapes.

After the moulding has been extruded it can be subjected to an additional processing step. Examples of such processing steps are afterstretching and thermoforming. Examples of aftertreated mouldings are mono- or biaxially stretched films and stretched fibres.

The extruded moulding according to the invention can be used in particular in the form of a film as packaging film, for instance for packaging of foodstuffs such as pasta, flowers, cigarettes, shirts, and as big and small bags, varying from sandwich bags to garbage bags.

The extruded moulding can also be a thin-walled packaging material, for instance a bottle, for soft drinks or shampoo for instance, or a tray or a cup.

The extruded moulding is also quite suitable for use in the form of a pipe, for instance for the conveyance of hot and cold water, as well as waste water and chemicals.

The invention will now be elucidated by means of Examples and comparative experiments without being limited hereto.

### EXAMPLES I-III and COMPARATIVE EXPERIMENTS A-B

Starting Products

A) Polyolefine

A1) Polypropylene homopolymer, Stamylan® P 15M00, DSM; melting temperature Tm=165° C. (determined with DSC (differential scanning calorimetry), at 10° C./,min).

B) Monomers

B1) Styrene, 99% stabilized with 10-15 ppm 4-t-butylcatechol, Aldrich

B2) Glycidyl methacrylate, 97% stabilized with 100 ppm monomethyl ether hydroquinone, Aldrich

C) Peroxide

C1) Trigonox C®, t-butyl-peroxi-benzoate, 98%, Aldrich

D) Layered clay

D1) Montmorillonite modified with dimethyldi(hydrogenated long hydrocarbon chains) ammonium chloride (125 mer), SCPX 1313, Southern Clay Products Inc.

E) Miscellaneous

E1) Irganox® B225, Ciba Specialty Compounds

Preparation of the Nanocomposite

A solution of the monomer or the monomers, the peroxide and optionally a UV stabilizer was prepared. This solution was added dropwise to the layered clay. When the clay had swollen, polymer powder was added, after which the whole was mixed on a mini-extruder (Cordewener, T=220° C., t=5 min., 200 rpm) . In the comparative experiments the UV stabilizer was added as a solid substance. The composition of the various polyolefin-based composite materials is shown in Table 1. The viscosity values of the various nanocomposites at different shearing rates are shown in Table 2. The viscosity was determined in accordance with ISO/DIN 6721-10.

Preparation of Extruded Moulding

The PP nanocomposites were processed to films on a Göttfert cast film processing equipment type 015.35.0. The cylinder length is 25D and the diameter is 30 mm. The slit width was 320 mm (nr 00284112A and 00284112B). The chill roll had a wind-up speed range of 0-15 m/min. The processing conditions were zone (1) 190, (2) 210, (3) 230 and (4) 240° C. and the split head was 250° C. The screw rotation speed was 95 rpm and the film had a thickness of 25 μm. The temperature of the chill roll was 20° C. The wind up speed for the PP nanocomposite was 11 m/min, while the comparative neat PP had a maximum wind up speed of 7 m/min. This indicates the improved processability of the product according to the present invention.

TABLE 1

| Example/ | | | | | |
|---|---|---|---|---|---|
| Comparative | Polyolefin | Clay | Monomer | Peroxide | Miscellaneous |
| experiment | (PO) (wt. %) | (wt. %) | (wt. %) | (wt. % rel. to PO) | (wt. % rel. to PO) |
| I | A1, 87 | D1, 10 | B1, 1 | C1, 0.14 | E1, 0.08 |
| | | | B2, 1 | | |
| II | A1, 83 | D1, 10 | B1, 5 | C1, 0.31 | E1, 0.18 |
| | | | B2, 2 | | |
| III | A1, 80 | D1, 10 | B1, 7 | C1, 0.44 | E1, 0.26 |
| | | | B2, 3 | | |
| A | A1, 100 | — | — | — | E1, 0.23 |
| B | A1, 90 | D1, 10 | — | — | E1, 0.23 |

TABLE 2

| Example/ | | | | | |
|---|---|---|---|---|---|
| comparative | | | | | |
| experiment | η* (ω = 0.1) | η* (ω= 1.0) | η* (ω= 10) | η* (ω= 100) | SVR |
| A | 5.4 · 10³ | 3.5 · 10³ | 1.6 · 10³ | 5.0 · 10² | 10.8 |
| B | 5.5 · 10³ | 3.5 · 10³ | 1.7 · 10³ | 5.4 · 10² | 10.2 |
| 1 | 2.0 · 10⁴ | 6.6 · 10³ | 2.3 · 10³ | 6.7 · 10² | 29.9 |
| 2 | 2.0 · 10⁴ | 6.8 · 10³ | 2.3 · 10³ | 6.6 · 10² | 30.3 |
| 3 | 3.2 · 10⁴ | 8.3 · 10³ | 2.5 · 10³ | 6.6 · 10² | 48.5 |

ω is the shear rate (rad/s)
η* is the viscosity (Pa · s)
$SVR = \frac{η * ( ω = 0.1 )}{η * ( ω = 100 )}$

What is claimed is:

1. Extruded moulding prepared from a polyolefin-based composite material, wherein the polyolefin-based composite material comprises 98-50 wt. % of a polyolefin, 1-50 wt. % of another homo- or copolymer and 0.1-70 wt. % of a layered, interstratified clay and in that the polyolefin-based composite material has an SVR-value of at least 15; the SVR-value being the ratio of the viscosity η* (in Pa.s) at a shear rate ω (in rad/s), of 0.1 and the viscosity η* at a shear rate of 100, the viscosity being determined according to ISO/DIN 6721-10.

2. Extruded polyolefin moulding according to claim 1, wherein the composite material is obtained by impregnating a layered, swellable clay which is interstratified with a tretaalkylonium cation, with at least one polymerizable monomer and them mixing this impregnated clay with a polyolefin and a peroxide, at a temperature above the melting temperature of the polyolefin.

3. Extruded polyolefin-based moulding according to claim 1, wherein the clay is montmorillonite.

4. Extruded polyolefin-based moulding according to claim 1, wherein the moulding contains 0.1-10 wt. % of clay.

5. Extruded polyolefin-based moulding according to claim 1, wherein the polyolefin is an ethylene homo- or copolymer or a propylene homo- or copolymer.

6. Extruded polyolefin-based moulding according to claim 1, wherein the polyolefin is chosen from isotactic polypropylene, high-density polyethylene or linear low-density polyethylene.

7. Extruded polyolefin-based moulding according to claim 1, wherein the moulding is a film.

8. Extruded polyolefin-based moulding according to claim 1, wherein the moulding has been aftertreated after being extruded.

9. Extruded polyolefin-based moulding according to claim 1, wherein the polyolefin-based composite material also comprises a nylon.

10. Extruded polyolefin-based moulding according to claim 1, wherein the SVR-value is at least 25.

11. Process for the manufacture of an extruded polyolefin-based moulding according to claim 1, wherein the moulding is contained by mixing a concentrate of the polyolefin-based composite material and a polyolefin.

12. Process according to claim 11, wherein the concentrate of the polyolefin-based composite material contains 10-70 wt. % of the clay.

13. Process according to claim 12, wherein the concentrate contains 40-60 wt. % of the clay.
